(19) United States
(12) Patent Application Publication
(10) Pub. No.: US 2003/0046501 A1
(43) Pub. Date: Mar. 6, 2003

(54) Method for interleaving memory

(76) Inventors: Jurgen M. Schulz, Pleasanton, CA (US); Andrew E. Phelps, Encinitas, CA (US)

Correspondence Address: HOYT A. FLEMING III, P.O. BOX 140678, BOISE, ID, 83714, US

(21) Appl. No.: 09/946,059

(22) Filed: Sep. 4, 2001

(51) Int. Cl. G06F 12/00

(52) U.S. Cl. 711/157; 711/5

(57) ABSTRACT

A method of interleaving a first bank of memory with a second bank of memory. The method is executed by a computer system having a memory controller that is coupled to a first plurality of memory devices that contains the first bank and a second plurality of memory devices that contains the second bank. The method includes: configuring the memory controller so that the memory controller is operable to read even and odd bytes of data from and write even and odd bytes of data to the first bank; storing even and odd bytes of data in the first bank; transferring the odd bytes of data from the first bank; and then reconfiguring the memory controller so that the memory controller is operable to read only even bytes of data from and write only even bytes of data to the first bank and the memory controller is operable to read only odd bytes of data from and write only odd bytes of data to the second bank.

### 1. FIELD OF THE INVENTION

The present invention generally relates to data processing systems and more particularly to methods of interleaving memory within a computer system.

### 2. BACKGROUND

Memory systems are well known in the art and such systems are used in many data processing applications. Memory systems provide program and operating data to central processing units, such as microprocessors, that enable the central processing units to execute program instructions. In applications where a large amount of memory space is required, such as in server applications, memory systems may include multiple memory banks. The memory banks may be formed with dynamic random access memories because of their extremely high memory density.

In order to access such memories, central processing units utilize various addressing and retrieval schemes to improve memory access time. One such scheme is known as interleaved memory. Memory interleaving is a process of organizing memory into different banks to reduce wait states. Sequential bytes of data are typically stored in alternate banks, so that the central processing unit alternates between banks when it reads sequential bytes. While one bank is being read, the other bank is cycling, so that the central processor does not have to wait.

Typically, memory devices (memory chips) are mounted on memory modules, which are installed into slots on a board, such as a memory-board or a motherboard, which includes one or more memory controllers. The memory controllers read data from and write data to the memory devices on the memory modules. In some cases, a single memory module will include one bank. In other cases, a single memory module will include two or more banks. In still other cases, a single memory module will include only a portion of a bank.

Interleaving is usually expressed in terms of the number of banks interleaved together. For example, a system described as having 8-way interleaving (interleaving factor of eight) may be divided into 8 banks with interleaved addresses. Locations in a first bank may store bytes 0, 8, 16, 24, etc., locations in a second bank may store bytes 1, 9, 17, 25, etc., locations in a third bank may story bytes 2, 10, 18, 26, etc. and so forth.

### 3. SUMMARY OF INVENTION

One embodiment of the invention is a method of interleaving a first bank of memory with a second bank of memory. The method can be executed by a computer system having a memory controller that is coupled to a first plurality of memory devices that contains the first bank and a second plurality of memory devices that contains the second bank. The method includes: configuring the memory controller so that the memory controller is operable to read even and odd bytes of data from and write even and odd bytes of data to the first bank; storing even and odd bytes of data in the first bank; transferring the odd bytes of data from the first bank; and then reconfiguring the memory controller so that the memory controller is operable to read only even bytes of data from and write only even bytes of data to the first bank and the memory controller is operable to read only odd bytes of data from and write only odd bytes of data to the second bank.

Another embodiment of the invention is another method of interleaving a first bank of memory with a second bank of memory. The method can be executed by a computer system having a memory controller coupled to a first plurality of memory devices that contains the first bank and a second bank. The method includes: configuring the memory controller so that the memory controller is operable to read even and odd bytes of data from and write even and odd bytes of data to the first bank; storing even and odd bytes of data in the first bank; transferring the odd bytes of data from the first bank; and then reconfiguring the memory controller so that the memory controller is operable to read only even bytes of data from and write only even bytes of data to the first bank and the memory controller is operable to read only odd bytes of data from and write only odd bytes of data to the second bank.

Still another embodiment of the invention is yet another method of interleaving a first bank of memory with a second bank of memory. This method can be executed by a computer system having a first memory controller coupled to a first plurality of memory devices that contains the first bank and a second memory controller coupled to a second plurality of memory devices that contains the second bank. The method includes: configuring the first memory controller so that the first memory controller is operable to read even and odd bytes of data from and write even and odd bytes of data to the first bank; storing even and odd bytes of data in the first bank; transferring the odd bytes of data from the first bank; then reconfiguring the first memory controller so that the first memory controller is operable to read only even bytes of data from and write only even bytes of data to the first bank; and configuring the second memory controller so that the second memory controller is operable to read only odd bytes of data from and write only odd bytes of data to the second bank.

Other embodiments of the invention include program storage devices containing instructions, that when executed by a computer system, perform a portion of the above methods.

### 4. BRIEF DESCRIPTION OF THE FIGURES

FIG. 1 presents a block diagram of a computer system.

FIG. 2 presents a flow diagram of one method to interleave two banks of memory.

FIG. 3 presents a non-interleaved bank of memory and two interleaved banks of memory.

FIG. 4 presents a block diagram of another computer system.

FIG. 5 presents a flow diagram of another method to interleave banks of memory.

FIG. 6 presents a non-interleaved bank of memory and four interleaved banks of memory.

FIG. 7 presents another block diagram of a computer system.

FIG. 8 presents another flow diagram of another method to interleave banks of memory.

FIG. 9 presents two non-interleaved banks of memory and two interleaved banks of memory.

FIG. 10 presents a block diagram of a more complex computer system.

### 5. DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

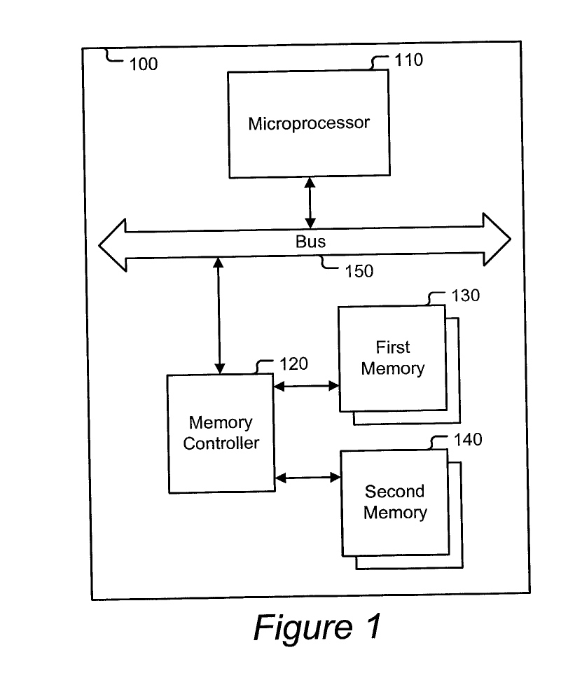

FIG. 1 presents a simplified block diagram of a computer system 100. The computer system 100 includes a microprocessor 110. In addition, the computer system 100 includes a memory controller 120, which is coupled to a first plurality of memory devices 130. The microprocessor 110 and the memory controller 120 are coupled together via a bus 150. Those skilled in the art will appreciate that the block diagram of FIG. 1 is simplified to illustrate only those functional elements of interest in describing the present invention. Other functional elements, such as redundant devices, an I/O bus, a PCI bus, bus controllers, etc., can also be interconnected with the depicted devices via bus 150. In order to simplify the description of the invention, it will be assumed that the first plurality of memory devices 130 includes only a single bank of memory that will be referred to as the first bank.

5.1 Method of Reconfiguring a Memory Controller to Interleave Two Banks

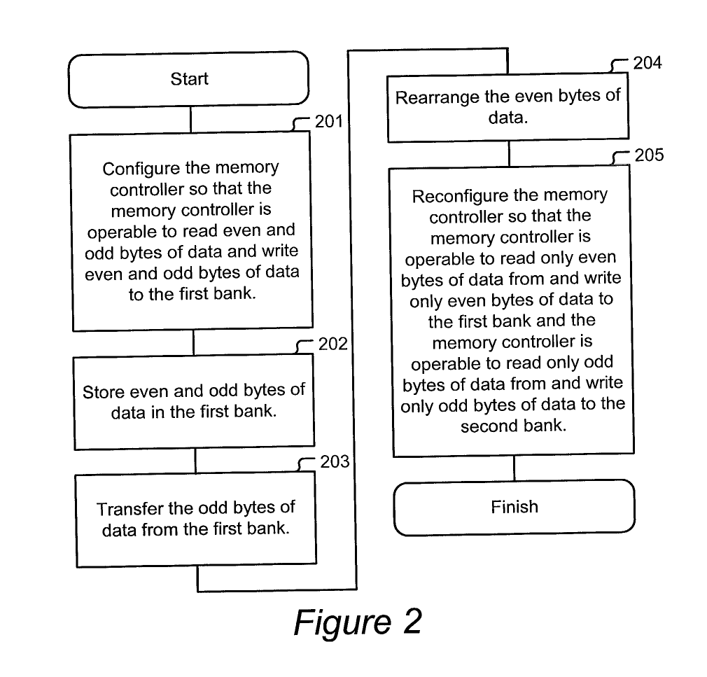

One embodiment of the invention, as shown in FIG. 2, is a method of interleaving the first bank with a second bank. The method allows the performance of the computer system 100 to be increased by modifying the interleaving scheme utilized by the memory controller 120 after the computer system 100 has begun performing useful tasks, such as executing operating system and application programs.

Referring to Block 201 of FIG. 2, the memory controller 120 would first be configured so that the memory controller 120 would access, i.e., read data from and write data to, the first bank. For example, the memory controller could be configured to store both even and odd bytes of data in the first bank under control of the operating system and/or application programs using a non-interleaved access scheme. Such an access scheme is also known by those skilled in the art as “no-way” or “high interleaving” access schemes. The configuration of the memory controller 120 may include storing data in one or more interleave registers within the memory controller 120. In some embodiments of the invention, firmware within the computer system (not shown) would configure the memory controller 120 when the computer system 100 is first booted.

After the memory controller is configured, then referring to Block 202 of FIG. 2, the memory controller 120 could then store both even and odd bytes of data into the first bank. For example, if the computer system 100 were executing an application program, such as a Web server program, then the Web server program could issue instructions that would cause the memory controller 120 to store both even and odd bytes of data in the first bank.

After the computer system 100 is running the Web server program, an administrator may desire to increase the performance of the computer system 100. For example, the number of users that the Web server program is supporting may have increased significantly and the computer system 100 needs the increase in performance to support the large number of users. Thus, the administrator may install the second plurality of memory devices 140, as shown in FIG. 1, to increase the computer system's performance. It is well known that increasing the amount of memory in a computer system often increases the computer system's performance. However, if the newly installed memory is interleaved with the prior memory, then the computer system's performance can be increased even further. Thus, the administrator may desire to interleave the first bank with a second bank within the second plurality of memory devices 140.

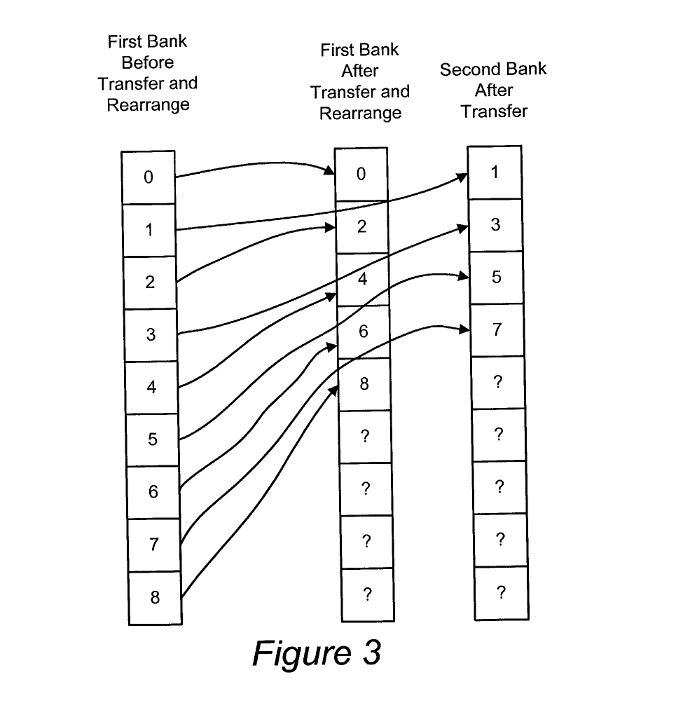

The administrator can begin to interleave the two banks by, referring to Block 203 of FIG. 2, first transferring, i.e., reading from and then storing in another bank, the odd bytes of data that were previously stored in the first bank. For example, the odd bytes of data could be read from memory locations within the first bank and then stored in memory locations within the second bank. In some embodiments of the invention, the odd bytes of data could be transferred as shown in FIG. 3.

Referring to Block 204 of FIG. 2, the even bytes of data stored in the first bank could be rearranged, i.e., read from and then stored in different memory locations within the same bank. For example, bytes 2, 4, 6, 8 etc. could be stored in memory locations 1,2, 3, 4, etc. within the bank as shown in FIG. 3. In such embodiments, byte 0 need not be rearranged.

In some embodiments of the invention, the odd bytes of data would be transferred before the even bytes of data were rearranged. In other embodiments of the invention, the odd bytes of data would be transferred after the even bytes of data were rearranged. However, in still other embodiments of the invention such as discussed in Section 5.4, the transferring of the odd bytes of data would be intermingled with the rearranging of the even bytes of data.

In some embodiments of the invention, the bytes of data could be transferred and/or rearranged while the operating system and/or one or more application programs are paused. By pausing such programs, data corruption can be avoided. Thus, in such embodiments, the administrator would need to pause the Web server program.

In other embodiments of the invention, the bytes of data could be transferred or rearranged while the operating system and/or one or more application programs are executing. Thus, the administrator would not need to pause the Web server program. In these embodiments, the operating system and/or application programs could instruct the memory controller to read and write even and odd bytes of data while the same bytes of data were being transferred or rearranged. In order to avoid data corruption in such embodiments of the invention, the memory controller could track the bytes that have been transferred and the bytes of data that have been rearranged. For example, if the tracking indicated that a byte of data had not been transferred or rearranged, then it could be accessed using a first access scheme in the first bank. If the tracking indicated that a byte of data had been transferred, then the memory controller could access the byte using a second access scheme. For example, using such an access scheme, if the byte was even, then it would be accessed in the first bank and if the byte was odd, then it would be accessed in the second bank. Alternatively, if the tracking indicated that the byte of data had been rearranged, then the memory controller could access the byte using a third access scheme.

After the transferring and rearranging were completed, then the first bank would be interleaved with the second bank and, referring to Block 205, the memory controller 120 could be reconfigured so that the memory controller 120 would only read and write even bytes of data to the first bank and would only read and write odd bytes of data to the second bank. Thus, the banks could be efficiently accessed using a 2-way interleave access scheme. As a result, the number of wait-states required to access the two banks would be decreased and the performance of the computer system 100 would be increased.

The above method could also be utilized to interleave two banks that are contained within a single plurality of memory devices.

5.2 Method of Reconfiguring a Memory Controller to Interleave 4, 8, 16, etc. Banks

Section 5.1 discloses methods of reconfiguring a memory controller to interleave two banks. Those methods can be easily modified to reconfigure a memory controller to interleave additional banks, such as those banks included in memory that were installed into a computer system after the computer system was running.

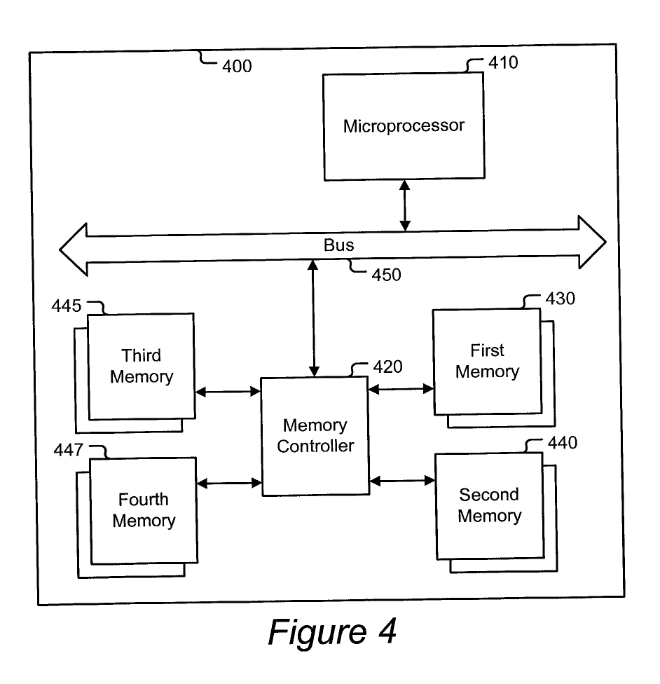

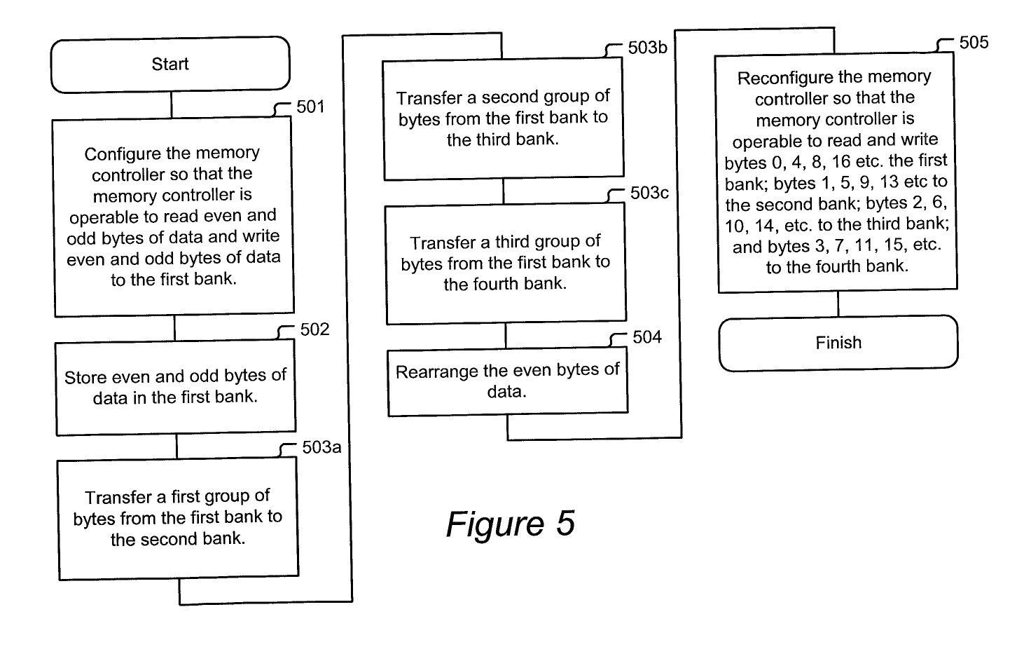

FIG. 4 presents a computer system 400 that includes 4 pluralities of memory devices 430, 440, 445, and 447. Each of the pluralities of memories 430, 440, 445, and 447 is coupled to a memory controller 420. Assuming that the first plurality of memory devices 430 includes a first bank, the second plurality of memory devices 440 includes a second bank, the third plurality of memory devices 445 includes a third bank, and the fourth plurality of memory devices 447 includes a fourth bank, using the method shown in FIG. 5, the four banks can be efficiently interleaved.

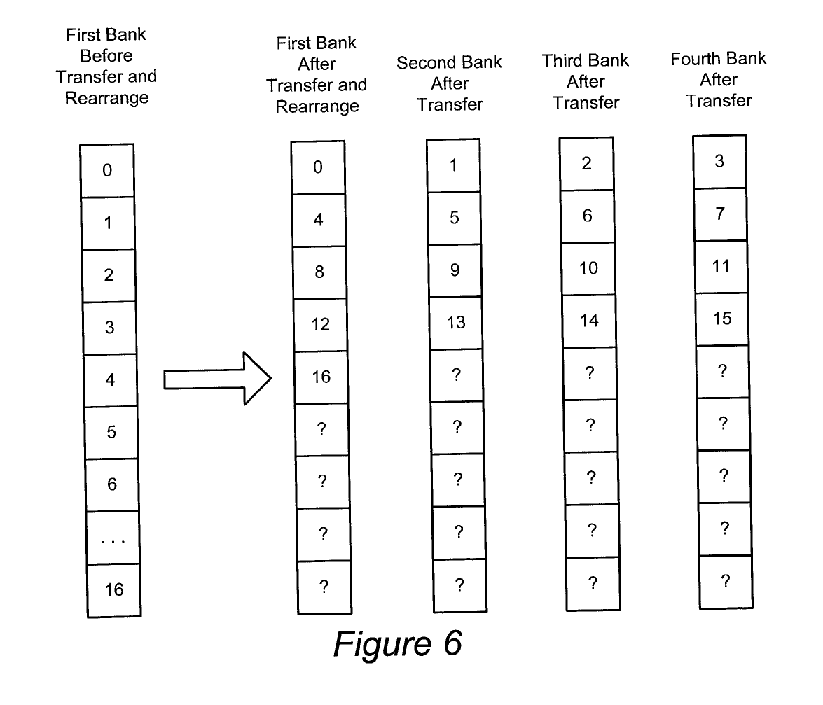

Referring to Block 501 of FIG. 5, the memory controller 420 could first be configured so that the memory controller 420 would access various bytes of data in the first bank. For example, the memory controller could be configured to access the first bank using a non-interleaved scheme. Next, referring to Block 502 of FIG. 5, the memory controller 420 could store various bytes of data in the first bank. Then, referring to Block 503a of FIG. 5, a first group of bytes, such as bytes 1, 5, 9, 13 etc., could be transferred from the first bank to the second bank. In addition, referring to Block 503b of FIG. 5, a second group of bytes, such as bytes 2, 6, 10, 14, etc., could be transferred from the first bank to the third bank. Similarly, referring to Block 503c of FIG. 5, a third group of bytes, such as bytes 3, 7, 11, 15, etc., could be transferred from the first bank to the fourth bank. In one embodiment of the invention, the bytes of data could be transferred from the first bank as shown in FIG. 6.

Referring to Block 504 of FIG. 5, bytes 4, 8, 12, 16, etc. in the first bank could be rearranged. For example, those bytes of data could be stored in memory locations 1, 2, 3, etc. within the first bank as shown in FIG. 6.

Next, referring to Block 505 of FIG. 5, the memory controller 420 could be reconfigured so that the memory controller 420 would only read and write bytes 0, 4, 8, 12, 16, etc. to and from the first bank. Similarly, the memory controller 420 could be reconfigured so that it would only read and write bytes 1, 5, 9, 13 etc. to and from the second bank; bytes 2, 6, 10, 14, etc. to the third bank; and bytes 3, 7, 11, 15, etc. to the fourth bank. Thus, the memory controller 420 could then access the four banks utilizing an efficient 4-way interleave scheme.

With the benefit of this disclosure, those of skill in the art could utilize variants of the above-methods to interleave 8, 16 or any other number of pluralities of memory devices.

5.3 Method of Reconfiguring Two Memory Controllers to Interleave Two Banks

Section 5.1 discloses methods of reconfiguring a memory controller to interleave two banks that are included within memory devices that are coupled to a single memory controller. Those methods can be modified to interleave two banks that are coupled to distinct memory controllers.

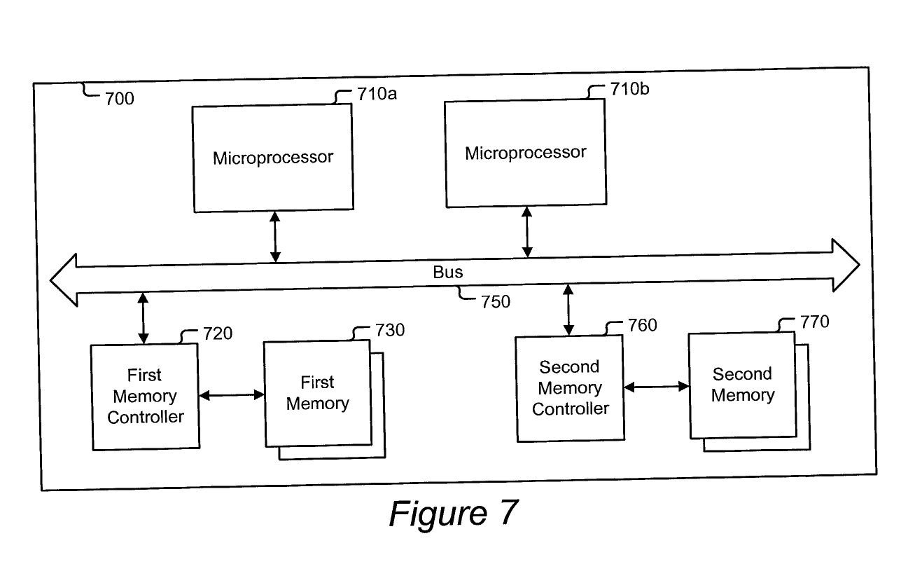

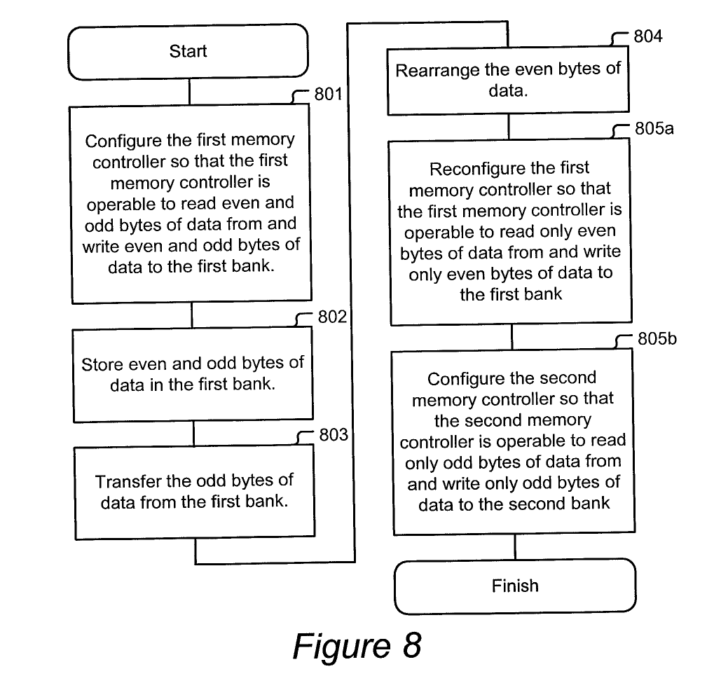

FIG. 7 presents a computer system 700 that includes two microprocessors 710a and 710b. In addition, the computer system 700 includes a first memory controller 720, which is coupled to a first plurality of memory devices 730. Further, the computer system 700 includes a second memory controller 760, which is coupled to a second plurality of memory devices 770. A bus 750 couples the microprocessors 710, the first memory controller 720, and the second memory controller 760 to each other. Assuming that the first plurality of memory devices 730 includes a first bank and the second plurality of memory devices includes a second bank, using the method shown in FIG. 8, the two banks can be efficiently interleaved.

Referring to Block 801 of FIG. 8, the first memory controller 720 could be configured so that the first memory controller 720 would read and write even and odd bytes of data to and from the first bank. For example, the first memory controller could be configured to read and write data to and from the first bank using a non-interleaved scheme. Next, referring to Block 802 of FIG. 8, the first memory controller 720 could store various bytes of data in the first bank. Then, referring to Block 803 of FIG. 8, the odd bytes of data could be transferred from the first bank to the second bank. In one embodiment of the invention, the bytes of data could be transferred from the first bank as shown in FIG. 3.

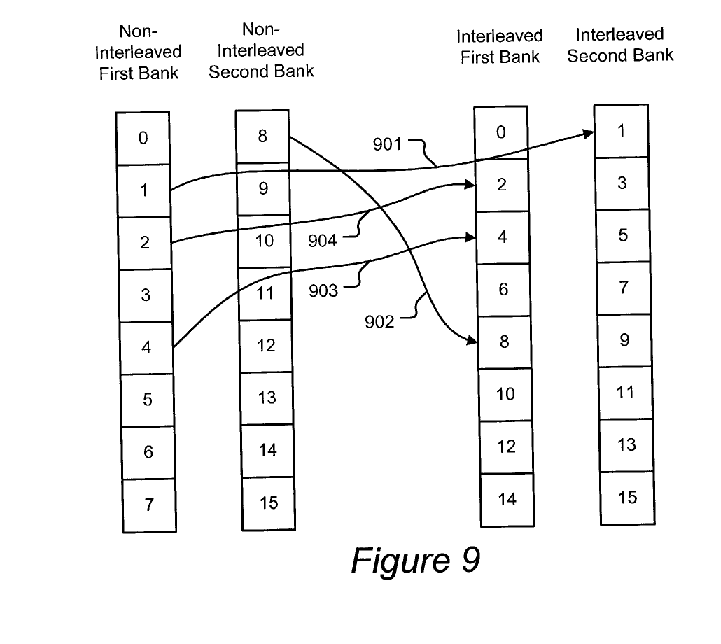

Referring to Block 804 of FIG. 8, the even bytes of data could be rearranged. For example, the even bytes of data could be stored in memory locations 1, 2, 3, etc. within the bank as shown in FIG. 9. Next, referring to Block 805a of FIG. 8, the first memory controller 720 could be reconfigured so that the first memory controller 720 would only read and write even bytes of data to and from the first bank. Similarly, referring to Block 805b of FIG. 8, the second memory controller 760 could be reconfigured so that it would only read and write odd bytes of data to and from the second bank. Thus, the two banks could be efficiently accessed using a 2-way interleave scheme.

5.4 Efficient Methods of Transferring and Rearranging Data

One method of efficiently interleaving data is by traversing an “interleave chain.” In this method, the transferring of odd bytes of data from a first bank is intermingled with the rearranging of even bytes of data in the first bank of memory. Thus, memory locations can be efficiently transferred and rearranged without the need for significant amounts of extra memory.

The first step in traversing the chain includes mapping a non-interleaved memory location to an interleaved memory location and then replacing the data in the interleaved memory location with the data from the non-interleaved memory location. Next, the previously replaced data is mapped to its interleaved memory location and the current data in the interleaved memory location is subsequently replaced. This process is repeated until the end of the chain is reached, i.e., the head of the interleave chain is equal to the tail of the interleave chain.

For example, if the two banks shown in FIG. 9 need to be converted from a non-interleaved storage scheme into a 2-way interleave storage scheme, interleave chain shown in FIG. 9 can be traversed.

First, the non-interleave memory location for byte 1 [bank 1, memory location 1] would be stored as the head of the interleave chain. Then, referring to link 901 of FIG. 9, [bank 1, memory location 1] would be mapped from its non-interleaved memory location to its interleaved memory location [bank 2, location 0]. The data previously stored in [bank 2, location 0] would then be stored in a temporary variable. Next, the data from [bank 1, memory location 1] would then be stored in [bank 2, location 0].

Then, the chain would be traversed to the next node. Referring to link 902 of FIG. 9, [bank 2, memory location 0] would be mapped from its non-interleaved memory location to its interleaved memory location [bank 1, memory location 4]. The data stored in this memory location would then be stored in a second temporary variable. Next, the data in the first temporary variable would be stored in [bank 1, location 4.] Then, the value of the second temporary variable would be stored in the first temporary variable.

Then, the interleave chain would be traversed to the next node. Referring to link 903 of FIG. 9, [Bank 1, location 4] would be mapped form its non-interleaved memory location to its interleaved memory location [bank 1, location 2]. The data stored in this memory location would then be stored in the second temporary variable. Next, the data in the first temporary variable would be stored in [bank 1, location 2.] Then, the value of the second temporary variable would again be stored in the first temporary variable.

Then, the interleave chain would be traversed to the next node. Referring to link 904 of FIG. 9, [bank 1, location 2] would be mapped form its non-interleaved memory location to its interleaved memory location [bank 1, location 1]. Because this memory location is equal to the memory location at the head of the interleave chain, the data in the first temporary variable would be stored in this memory location and the traversing of the interleave chain would cease.

After the traversal of the above interleave chain has been completed, the next memory location that has not been traversed (whether in the current bank or in the next bank) would be located. Referring to FIG. 9, that memory location would be [bank 1, memory location 3]. This memory location would then be utilized as the head of a second interleave chain. The traversal of this chain would be similar to the traversal of the interleave chain discussed above.

By continuing the above process until all the memory locations had been traversed, then the memory banks could be efficiently converted from a non-interleaved storage scheme into an 2-way interleaved storage scheme.

With the benefit of this disclosure, one of skill in the art will understand that the above method can be utilized to convert a non-interleave storage scheme into a 4-way, 8-way, or 16-way interleave storage scheme, for example.

In addition, with the benefit of this disclosure, one of skill in the art will understand that similar interleave chains can be utilized to convert an interleave storage scheme, such as a 2-way or 4-way interleave storage scheme, into a non-interleave storage scheme. Then, the non-interleave storage scheme could be converted, using additional interleave chains, into an 8-way, or 16-way interleave storage scheme. Further, such conversions can take place while the computer system is executing application programs such as Web server programs without data corruption.

5.5 Other Embodiments of the Invention

Section 5.1 describes methods of interleaving two banks that are coupled to a single memory controller. Section 5.2 describes methods of interleaving a larger number of banks that are coupled to a single memory controller. Section 5.3 describes methods of interleaving two banks that are coupled to different memory controllers. Just as the methods described in Section 5.1 were extended to the methods described in Section 5.2, with the benefit of this disclosure, the methods of Section 5.3 can be extended to allow interleaving of any number of banks.

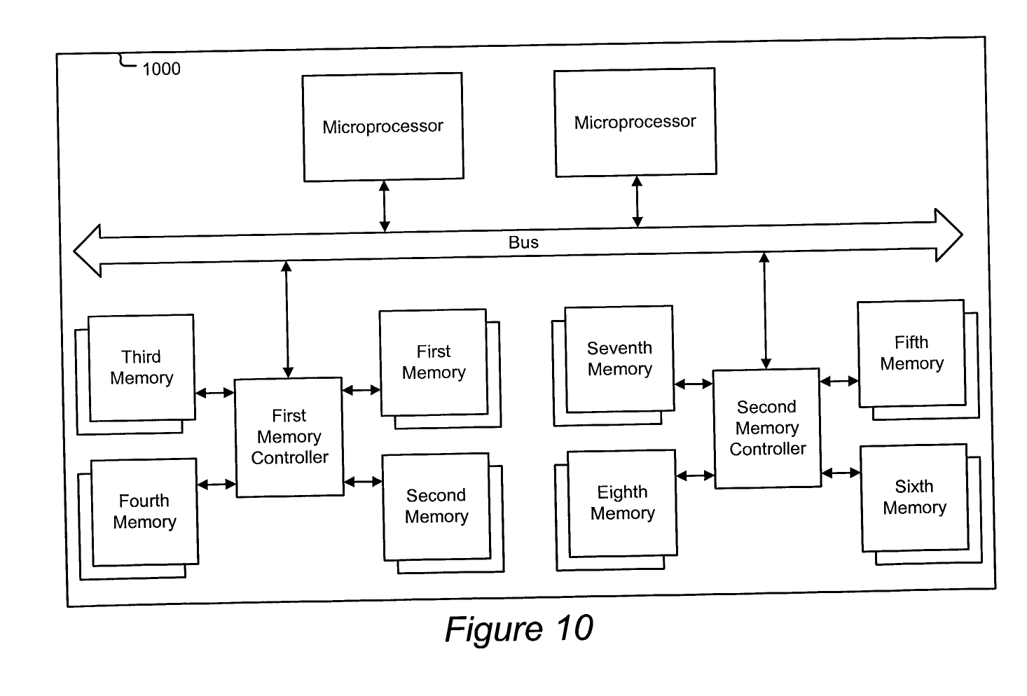

In addition, the methods of the previous section may be combined. For example, the computer system 1000 shown in FIG. 10 includes eight pluralities of memory devices. Four of the pluralities of memory devices are coupled to the first memory controller while four of the pluralities of memory devices are coupled to the second memory controller. Assuming that each plurality of memory devices includes a single bank, by combining the methods discussed above, the pluralities of memory devices may be accessed utilizing 8-way interleaving. Further, if the computer contained additional memory controllers and pluralities of memory devices, then they could also be interleaved using the methods described above.

5.6 Conclusion

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. For example, program storage devices, such as floppy disks, hard disks, compact disks (CDs), digital versatile disks (DVDs), read only memory (ROM), programmable read only memory (PROMs), or random access memory (RAM), that contain computer readable instructions that when executed by a computer system, implement any of the above described methods are intended to be within the present invention. Additionally, the above disclosure is not intended to limit the present invention. The scope of the present invention is defined by the appended claims.

It is claimed:

1. A method of interleaving a first bank of memory with a second bank of memory, the method executed by a computer system having a memory controller coupled to a first plurality of memory devices that contains the first bank and a second plurality of memory devices that contains the second bank, the method comprising:
a) configuring the memory controller so that the memory controller is operable to read even and odd bytes of data from and write even and odd bytes of data to the first bank;
b) storing even and odd bytes of data in the first bank;
c) transferring the odd bytes of data from the first bank; and then
d) reconfiguring the memory controller so that the memory controller is operable to read only even bytes of data from and write only even bytes of data to the first bank and the memory controller is operable to read only odd bytes of data from and write only odd bytes of data to the second bank.

2. The method of claim 1, wherein the act of configuring the memory controller includes configuring the memory controller so that the memory controller is operable to read even and odd bytes of data from and write even and odd bytes of data to the first bank based upon instructions issued by an application program.

3. The method of claim 1, wherein the act of configuring the memory controller includes storing a value in an interleave register within the memory controller.

4. The method of claim 1, wherein the act of storing even and odd bytes of data in the first bank includes storing even and odd bytes of data based upon instructions issued by an application program.

5. The method of clam 1, wherein the act of transferring odd bytes of data includes traversing an interleave chain.

6. The method of clam 1, wherein the act of transferring odd bytes of data includes traversing a plurality of interleave chains.

7. The method of claim 1, wherein the act of transferring the odd bytes of data from the first bank occurs while the memory controller is operable to read even and odd bytes of data based upon instructions issued by the application program.

8. The method of claim 1, wherein the act of transferring the odd bytes of data from the first bank includes transferring the odd bytes of data from the first bank to the second bank.

9. The method of claim 1, wherein the act of transferring the odd bytes of data from the first bank includes transferring a first portion of the odd bytes of data from the first bank to the second bank and transferring a second portion of the odd bytes of data to a third bank.

10. The method of claim 1, wherein the act of transferring the odd bytes of data from the first bank includes transferring a first portion of the even bytes of data from the first bank to a third bank and transferring a first portion of the odd bytes of data from the first bank to the second bank and transferring a second portion of the odd bytes of data to a fourth bank.

11. The method of claim 1, wherein the act of transferring the odd bytes of data from the first bank includes rearranging bytes 2, 4, 6, and 8 within the first bank.

12. The method of claim 1, wherein the act of configuring the memory controller includes configuring the memory controller so that the memory controller is operable to only read even bytes of data from and operable to only write even bytes of data to the first bank and is operable to only read odd bytes of data from and operable to only write odd bytes of data to the second bank based upon instructions issued by an application program.

13. A method of interleaving a first bank of memory with a second bank of memory, the method executed by a computer system having a memory controller coupled to a first plurality of memory devices that contains the first bank and a second bank, the method comprising:
a) configuring the memory controller so that the memory controller is operable to read even and odd bytes of data from and write even and odd bytes of data to the first bank;
b) storing even and odd bytes of data in the first bank;
c) transferring the odd bytes of data from the first bank; and then
d) reconfiguring the memory controller so that the memory controller is operable to read only even bytes of data from and write only even bytes of data to the first bank and the memory controller is operable to read only odd bytes of data from and write only odd bytes of data to the second bank.

14. The method of claim 13, wherein the act of configuring the memory controller includes configuring the memory controller so that the memory controller is operable to read even and odd bytes of data from and write even and odd bytes of data to the first bank based upon instructions issued by an application program.

15. The method of claim 13, wherein the act of configuring the memory controller includes storing a value in an interleave register within the memory controller.

16. The method of claim 13, wherein the act of storing even and odd bytes of data in the first bank includes storing even and odd bytes of data based upon instructions issued by an application program.

17. The method of clam 13, wherein the act of transferring odd bytes of data includes traversing an interleave chain.

18. The method of clam 13, wherein the act of transferring odd bytes of data includes traversing a plurality of interleave chains.

19. The method of claim 13, wherein the act of transferring the odd bytes of data from the first bank occurs while the memory controller is operable to read even and odd bytes of data based upon instructions issued by the application program.

20. The method of claim 13, wherein the act of transferring the odd bytes of data from the first bank includes transferring the odd bytes of data from the first bank to the second bank.

21. The method of claim 13, wherein the act of transferring the odd bytes of data from the first bank includes transferring a first portion of the odd bytes of data from the first bank to the second bank and transferring a second portion of the odd bytes of data to a third bank.

22. The method of claim 13, wherein the act of transferring the odd bytes of data from the first bank includes transferring a first portion of the even bytes of data from the first bank to a third bank and transferring a first portion of the odd bytes of data from the first bank to the second bank and transferring a second portion of the odd bytes of data to a fourth bank.

23. The method of claim 13, wherein the act of transferring the odd bytes of data from the first bank includes rearranging bytes 2, 4, 6, and 8 within the first bank.

24. The method of claim 13, wherein the act of configuring the memory controller includes configuring the memory controller so that the memory controller is operable to only read even bytes of data from and operable to only write even bytes of data to the first bank and is operable to only read odd bytes of data from and operable to only write odd bytes of data to the second bank based upon instructions issued by an application program.

25. A method of interleaving a first bank of memory with a second bank of memory, the method executed by a computer system having a first memory controller coupled to a first plurality of memory devices that contains the first bank and a second memory controller coupled to a second plurality of memory devices that contains the second bank, the method comprising:
a) configuring the first memory controller so that the first memory controller is operable to read even and odd bytes of data from and write even and odd bytes of data to the first bank;
b) storing even and odd bytes of data in the first bank;
c) transferring the odd bytes of data from the first bank; then
d) reconfiguring the first memory controller so that the first memory controller is operable to read only even bytes of data from and write only even bytes of data to the first bank; and
e) configuring the second memory controller so that the second memory controller is operable to read only odd bytes of data from and write only odd bytes of data to the second bank.

26. The method of claim 25, wherein the act of configuring the first memory controller includes configuring the first memory controller so that the first memory controller is operable to read even and odd bytes of data from and write even and odd bytes of data to the first bank based upon instructions issued by an application program.

27. The method of claim 25, wherein the act of configuring the first memory controller includes storing a value in an interleave register within the first memory controller.

28. The method of claim 25, wherein the act of storing even and odd bytes of data in the first bank includes storing even and odd bytes of data based upon instructions issued by an application program.

29. The method of clam 25, wherein the act of transferring odd bytes of data includes traversing an interleave chain.

30. The method of clam 25, wherein the act of transferring odd bytes of data includes traversing a plurality of interleave chains.

31. The method of claim 25, wherein the act of transferring the odd bytes of data from the first bank occurs while the memory controller is operable to read even and odd bytes of data based upon instructions issued by the application program.

32. The method of claim 25, wherein the act of transferring the odd bytes of data from the first bank includes transferring the odd bytes of data from the first bank to the second bank.

33. The method of claim 25, wherein the act of transferring the odd bytes of data from the first bank includes transferring a first portion of the odd bytes of data from the first bank to the second bank and transferring a second portion of the odd bytes of data to a third bank.

34. The method of claim 25, wherein the act of transferring the odd bytes of data from the first bank includes transferring a first portion of the even bytes of data from the first bank to a third bank and transferring a first portion of the odd bytes of data from the first bank to the second bank and transferring a second portion of the odd bytes of data to a fourth bank.

35. The method of claim 25, wherein the act of transferring the odd bytes of data from the first bank includes rearranging bytes 2, 4, 6, and 8 within the first bank.

36. The method of claim 25, wherein the act of configuring the memory controller includes configuring the memory controller so that the memory controller is operable to only read even bytes of data from and operable to only write even bytes of data to the first bank and is operable to only read odd bytes of data from and operable to only write odd bytes of data to the second bank based upon instructions issued by an application program.

37. A program storage device, containing computer readable instructions, that when executed by a computer system having a memory controller coupled to a first plurality of memory devices that contains a first bank and a second plurality of memory devices that contains a second bank, interleaves the first bank of memory with the second bank of memory by performing the following acts:
a) configuring the memory controller so that the memory controller is operable to read even and odd bytes of data from and write even and odd bytes of data to the first bank;
b) transferring odd bytes of data from the first bank;
c) rearranging even bytes of data within the first bank; and then
d) reconfiguring the memory controller so that the memory controller is operable to read only even bytes of data from and write only even bytes of data to the first bank and the memory controller is operable to read only odd bytes of data from and write only odd bytes of data to the second bank.

38. A program storage device, containing computer readable instructions, that when executed by a computer system having a memory controller coupled to a plurality of memory devices that contains a first bank and a second bank, interleaves the first bank of memory with the second bank of memory by performing the following acts:
a) configuring the memory controller so that the memory controller is operable to read even and odd bytes of data from and write even and odd bytes of data to the first bank;
b) transferring odd bytes of data from the first bank;
c) rearranging even bytes of data within the first bank; and then
d) reconfiguring the memory controller so that the memory controller is operable to read only even bytes of data from and write only even bytes of data to the first bank and the memory controller is operable to read only odd bytes of data from and write only odd bytes of data to the second bank.

39. A program storage device, containing computer readable instructions, that when executed by a computer system having a first memory controller coupled to a first plurality of memory devices that contains a first bank and a second memory controller that is coupled to a second plurality of memory devices that contains a second bank, interleaves the first bank of memory with the second bank of memory by performing the following acts:
a) configuring the first memory controller so that the memory controller is operable to read even and odd bytes of data from and write even and odd bytes of data to the first bank;
b) transferring odd bytes of data from the first bank;
c) rearranging even bytes of data within the first bank; and then
d) reconfiguring the first memory controller so that the memory controller is operable to read only even bytes of data from and write only even bytes of data to the first bank;
e) configuring the second memory controller so that the second memory controller is operable to read only odd bytes of data from and write only odd bytes of data to the second bank.
